(19) United States
(12) Patent Application Publication
(10) Pub. No.: US 2026/0036254 A1
(43) Pub. Date: Feb. 5, 2026

(54) MOUNTING DEVICE FOR A DISPLAY

(71) Applicant: Google LLC, Mountain View, CA (US)

(72) Inventors: Guillermo Fabian Díaz Lankenau, Santa Cruz, CA (US); Antonio Yamil Layon Halun, Mountain View, CA (US)

(21) Appl. No.: 18/792,242

(22) Filed: Aug. 1, 2024

(51) Int. Cl. F16M 13/02; F16M 11/08; H04N 5/655

(52) U.S. Cl. CPC F16M 13/022; F16M 11/08; H04N 5/655

(57) ABSTRACT

Systems and devices are disclosed for improving image quality in a video communication system. Improvements can be realized through the use of a display mount that provides for repeatable positioning and loading. Cameras can be mounted around a perimeter of the display, so that the principles described apply to a camera array structure as well as the display itself. The display mount can include an upper fixed mount that restricts translational motion and a lower flexible mount that permits rotation about a vertical axis to compensate for variations in loading. Various implementations of the upper mount are described. The upper mount can be equipped with a roll adjustment mechanism.

### FIELD OF THE DISCLOSURE

The present disclosure relates to a system for video communication with improved image quality.

### BACKGROUND

Video communication systems, e.g., systems used for three-dimensional (3D) video conferencing or video chats, facilitate collaboration in real space. Augmented reality (AR) or virtual reality (VR) systems can deliver a more comprehensive user experience, but they require users to wear headsets that transition the user from their natural environment into an immersive virtual space.

### SUMMARY

The present disclosure describes devices and systems for improving image quality in a 3D video communication system, through the use of a display mount that provides for repeatable positioning and loading.

In some aspects, the techniques described herein relate to a device for mounting a display to a fixed structure, the device including: a first mounting plate attached to the fixed structure, the first mounting plate having a first slot and a second slot to accept ring grooved pins attached to the display; a second mounting plate configured to pivot about a vertical axis, the second mounting plate configured to accept contact pins attached to the display; a flat plate attached to the fixed structure, the flat plate configured to support a lower portion of the second mounting plate; and an adjustable bracket attached to the fixed structure, the adjustable bracket configured to support an upper portion of the second mounting plate, the adjustable bracket configured to permit compensatory motion of the display.

In some aspects, the techniques described herein relate to a system, including: a mount attached to a fixed structure, the mount configured to restrict translational motion of a hanging object relative to the fixed structure; and a flexure bracket attached to the fixed structure, the flexure bracket configured to permit rotational motion of the hanging object around a single axis.

The foregoing illustrative summary, as well as other exemplary objectives and/or advantages of the disclosure, and the manner in which the same are accomplished, are further explained within the following detailed description and its accompanying drawings.

### BRIEF DESCRIPTION OF THE DRAWINGS

FIG. 1 is a pictorial view of a 3D video communication system according to a possible implementation of the present disclosure.

FIG. 2 is a perspective view of a front side of a 3D light field display according to a possible implementation of the present disclosure.

FIG. 3 is a perspective view of a mounting system for a 3D light field display, according to a possible implementation of the present disclosure.

FIGS. 4A-4C illustrate hardware components of the mounting system for attachment to the display, according to a possible implementation of the present disclosure.

FIG. 5A is a side elevation view of a fixed plate assembly, according to a possible implementation of the present disclosure.

FIG. 5B is a side elevation view of a pivoting plate assembly, according to a possible implementation of the present disclosure.

FIG. 6 is an end view of a display mounted to a fixed structure using the mounting system described herein, according to a possible implementation of the present disclosure.

FIG. 7A is magnified end view of the pivoting plate assembly, according to a possible implementation of the present disclosure.

FIG. 7B is a bottom view of the pivoting plate assembly, according to a possible implementation of the present disclosure.

FIGS. 8A, 8B, and 8C are views of the pivoting plate assembly equipped with a roll adjustment mechanism, according to a possible implementation of the present disclosure.

FIGS. 9A and 9B illustrate a top mounting assembly, according to a possible implementation of the present disclosure.

FIGS. 10A and 10B illustrate a mounting assembly, according to a possible implementation of the present disclosure.

FIGS. 10C and 10D illustrate support structures for use with the mounting assembly shown in FIGS. 10A and 10B, according to a possible implementation of the present disclosure.

Components in the drawings are not necessarily to scale relative to each other. Like reference numerals designate corresponding parts throughout the several views.

### DETAILED DESCRIPTION

An enhanced video communication system is possible in which a user's image is presented as a 3D model, without a need to wear an AR/VR headset. In the enhanced video communication system, for example, each user sits in a booth facing a light field display that includes a projection system and an array of cameras and lights directed at different angles. The light field display projects a 3D, hologram-like, life-size image of the user, for viewing by other, remote users. With such an arrangement, the video communication experience feels more realistic because the 3D imaging provides live volumetric capture that transmits body language and subtle facial expressions, not just a flat image of a “talking head.” Consequently, remote users can feel as though they are in the same room together.

3D lightfield displays can produce an autostereoscopic effect that enables an observer to perceive image depth (3D) without wearing special headgear. A stereoscopic effect can be created by a projection system that positions copies of an image in front of a user's left eye and right eye that are shifted horizontally relative to each other. An example 3D lightfield display uses lenticular optics to provide the autostereoscopic effect. The lenticular optics may be implemented as a series of vertically-oriented cylindrical camera lenses formed on a sheet, e.g., a lenticular film, that is fitted onto a display screen, to form an integrated 3D camera system. In some implementations, the lenses are formed as a 2D matrix covering the area of the display screen. In some implementations, the lenses are formed around an outer bezel of the display screen. In either arrangement, to precisely record and reproduce three-dimensional video, it is important that the shape of the display and the position of the camera array are known with high precision, and can be maintained for the entirety of the video session.

At least one technical problem with such 3D light field displays that combine multiple video feeds into a composite 3D image is that the video quality is diminished if the position of any one of the cameras varies. Precise camera positions cannot be maintained simply by manufactured assembly interfaces. Instead, the position of cameras and shape of displays are calibrated after assembly is complete. Such calibration is performed at the factory and then assumed to be consistent with the product as installed at the end user's site. A problem with this assumption is that display mounts are not exactly constrained, which means the display and camera assembly will slightly deform to correctly interface with the mount being used. Since the mounts at the end-user are not identical to those at the factory, they will deform the display and camera assembly in different ways. Consequently, the factory calibration may no longer be applicable, causing the position assumptions for cameras and displays to be crroncous.

The disclosed systems and methods provide a technical solution to the challenge of consistency in display mounting. If a display is dis-mounted, e.g., removed from a wall and replaced, the devices described herein can be used to ensure that re-mounting the display is reproducible, without a need for re-calibration. With adequate constraints, small variations in the wall or brackets will not transfer indeterminate forces to the display during new mounting events, environmental changes, or other disturbances.

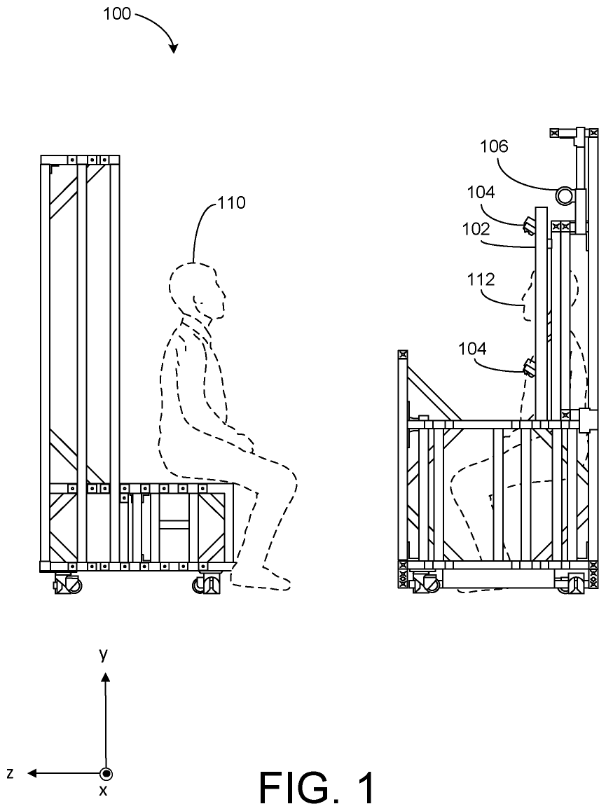

FIG. 1 shows a 3D video communication system 100 according to a possible implementation of the present disclosure. The 3D video communication system 100 includes a display 102, e.g., an optical display, onto which an array of display cameras 104 (two shown) are mounted in a precise arrangement. In some implementations, lenses of the display cameras 104 can be formed on a lenticular film attached to the display 102. Stress can alter positions of the display cameras 104 attached to the central area of the display 102 or to the perimeter of the display 102. Additionally, or alternatively, a frame camera 106 and/or light can be mounted on a separate frame above, below, or adjacent to the display 102.

A local user 110 can be seated opposite the display 102, to observe a 3D image 112 of a remote user. The local user 110 can be seated a few fect from the display 102, at a distance that would normally separate two people meeting together in the same room. The multiple display cameras 104 and the frame camera(s) 106 are focused simultaneously on the local user 110 to provide the remote user with a similar 3D image of the local user 110.

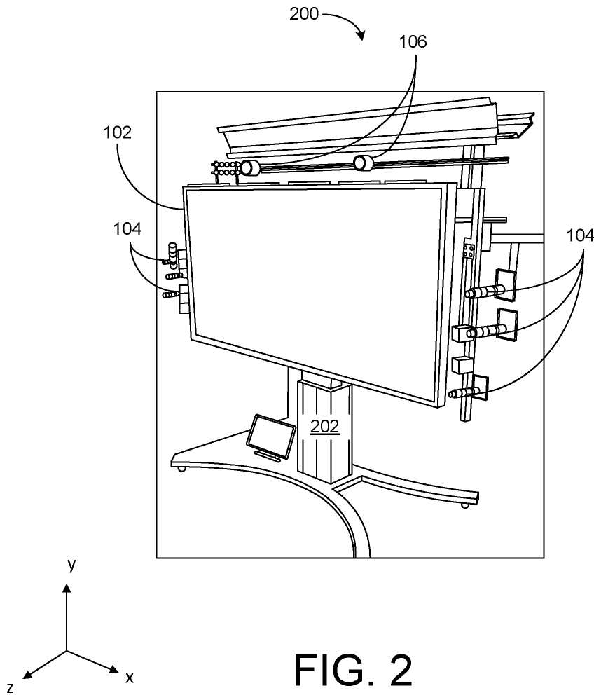

FIG. 2 shows a front view 200 of an example of the display 102, according to a possible implementation of the present disclosure. In FIG. 2, display cameras 104 (5 shown) are arranged around a perimeter, e.g., on a bezel, of the display 102. The display 102 can be supported by a frame 202. In some implementations, frame cameras 106 (2 shown) can be mounted to the frame 202, above, below, or to the sides of the display 102. A backplate 212 covers a back side of the display 102.

One of the challenges of the 3D video communication system 100 is to maintain accurate camera positions to successfully combine the video feeds from the various cameras. If the camera positions vary with respect to one another, the video image quality is diminished as the overlay of the video images becomes mis-aligned. Even cameras mounted to stationary structures can move due to thermal distortions of the structure or small applied loads. A major source of heat of the 3D communication system 100 is the display, therefore display mounted cameras 104 are likely to move more due to thermal distortion than frame mounted cameras 106. However, even frame mounted cameras 106 experience unacceptably large motions due to thermal distortions or intermittently applied forces. In some implementations, a choice of materials used in the display 102 or in the frame 202 can minimize distortion, for example, by substituting carbon fiber for aluminum. However, such materials may be cost-prohibitive.

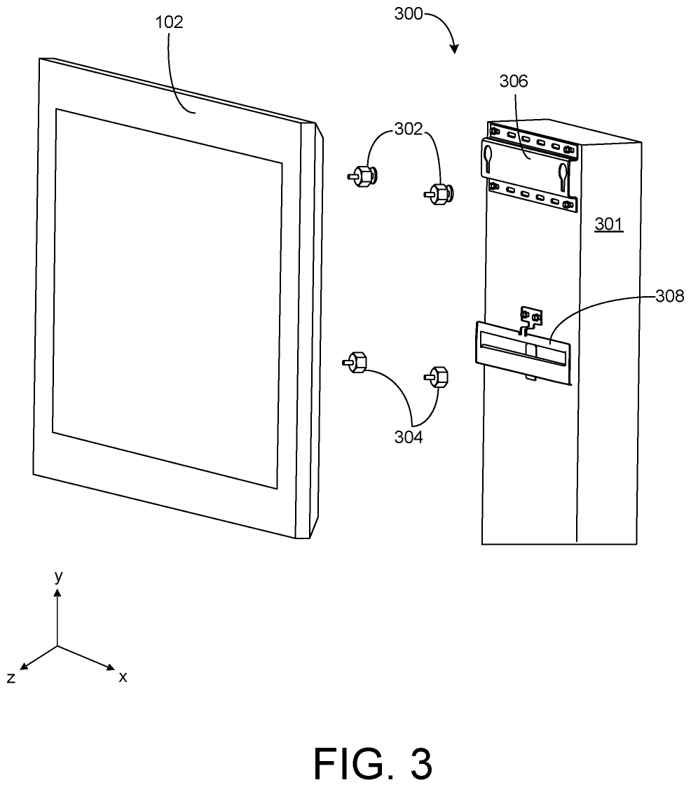

FIG. 3 shows a mounting system 300 for mounting an object, e.g., the display 102, to a fixed structure 301, according to a possible implementation of the present disclosure. Although this description focuses on the display 102 as the object, the mounting system 300 is not so limited. The mounting system 300 can be used to mount items other than a display, e.g., mirrors, artwork, or any other hanging object that is compatible with elements of the mounting system 300. The mounting system 300 can be used to ensure repeatable positioning of the object relative to the fixed structure 301. The mounting system 300 can also be used to ensure repeatable loading, or weight distribution, of the object relative to the fixed structure 301.

In some implementations, the mounting system 300 includes ring grooved pins 302, contact pins 304, a first mount in the form of a fixed plate assembly 306, and a second mount in the form of a pivoting plate assembly 308. The ring grooved pins 302 and the contact pins 304 attach to the display 102 by, for example, screw threads or a pressure fit. The ring grooved pins 302 mate with the fixed plate assembly 306; the contact pins 304 mate with the pivoting plate assembly 308. One or both of the ring grooved pins 302 and the contact pins 304 can be radially symmetric.

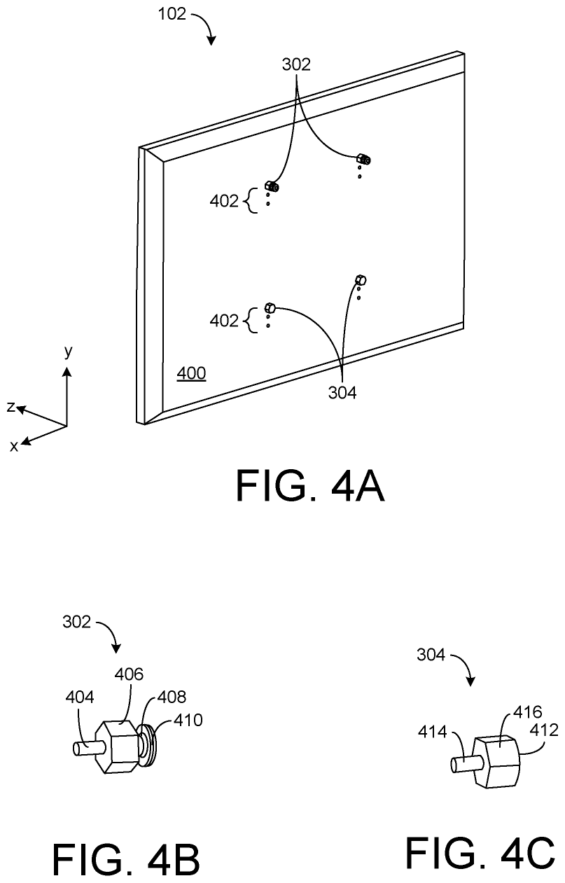

FIGS. 4A, 4B, and 4C show details of the ring grooved pins 302 and the contact pins 304, according to a possible implementation of the present disclosure.

FIG. 4A is a rear perspective view of the display 102, according to a possible implementation of the present disclosure. In some implementations, parts of the display 102 can include a back surface 400 and holes 402. FIG. 4A shows positioning of the ring grooved pins 302 and the contact pins 304 on the back surface 400 of the display 102. Multiple sets of the holes 402 can be provided, e.g., drilled into the back surface 400, or formed in the back surface 400 during manufacturing, to receive the ring grooved pins 302 and the contact pins 304. The holes 402 can provide flexibility in positioning the display 102 relative to the fixed structure 301.

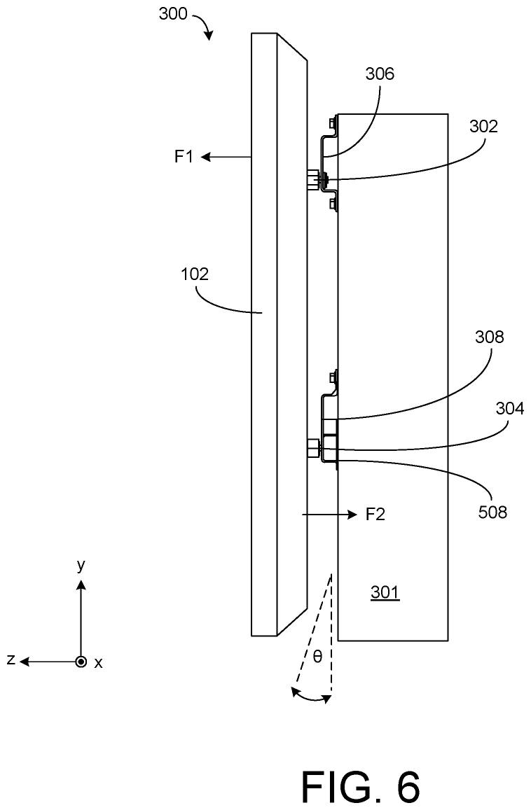

FIG. 4B is a magnified view of a ring grooved pin 302, according to a possible implementation of the present disclosure. The ring grooved pins 302 can be inserted into holes 402 in the back surface 400 of an upper portion of the display 102 to couple the display 102 to the fixed plate assembly 306. In some implementations, parts of each ring grooved pin 302 can include a rod 404, a body portion 406, a groove 408, and a pin head 410. In some implementations, the rod 404 is a cylindrical structure that can be inserted into one of the multiple sets of holes 402 in the back surface 400 of the display 102. The body portion 406 provides a stop that defines a maximum length of the rod 404 that can be inserted into the back surface 400. In some implementations, the body portion 406 may be a hexagonal-shaped body, which may enable for gripping and tightening by a tool and/or by fingers. The fixed plate assembly 306 can then engage the groove 408 as shown in FIG. 6 and as described in further detail below.

FIG. 4C is a magnified view of the contact pin 304, according to a possible implementation of the present disclosure. The contact pins 304 can be inserted into a lower portion of the display 102 to contact the pivoting plate assembly 308. In some implementations, parts of each contact pin 304 can include a rod 414 and a body portion 416, where the body portion 416 has a top surface 412. In some implementations, the rod 414 is a cylindrical structure similar to the rod 404 that can be inserted into one of the multiple sets of holes 402 in the back surface 400 of the display 102. The body portion 416 provides a stop that imposes a maximum length of the rod 404 that can be inserted into the back surface 400 and may be similar to the body portion 406. In some implementations, the body portion 416 may be a hexagonal-shaped body, which may enable for gripping and tightening by a tool and/or by fingers. The pivoting plate assembly 308 can then engage with the top surface 412 of the body portion 416 as shown in FIG. 6 and as described in further detail below.

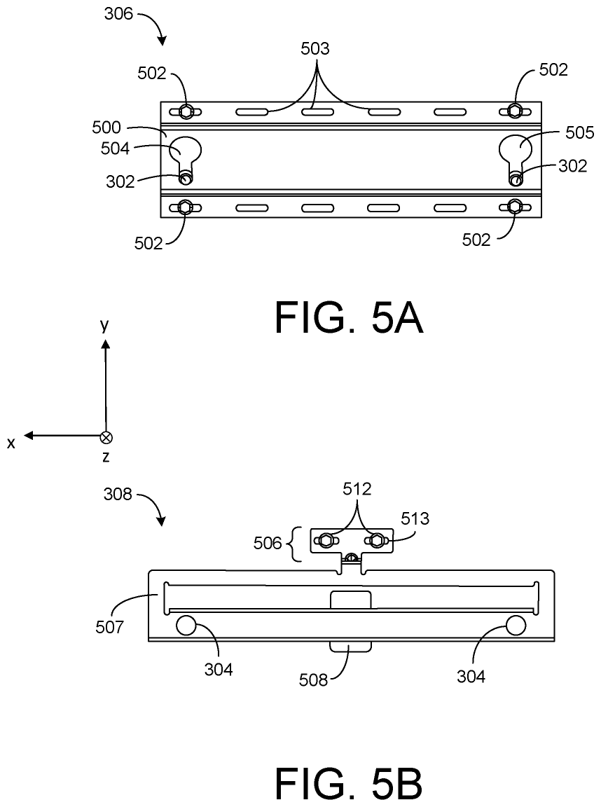

FIGS. 5A and 5B show details of the fixed plate assembly 306 and the pivoting plate assembly 308, respectively, according to a possible implementation of the present disclosure. In particular, FIG. 5A shows how the fixed plate assembly 306 couples to the ring grooved pins 302, and FIG. 5B shows how the pivoting plate assembly 308 makes contact with the contact pins 304.

FIG. 5A is a side elevation view of the fixed plate assembly 306, according to a possible implementation of the present disclosure. In some implementations, parts of the fixed plate assembly 306 can include a fixed plate 500, fasteners 502 (e.g., screws, bolts, nails, etc.), elongated fastener holes 503, a tapered slot 504, and a rectangular slot 505. In some implementations, the tapered slot 504 can resemble a first keyhole shape having a tapered lower end, and the rectangular slot 505 can resemble a second keyhole shape, having a rectangular lower end. The fixed plate assembly 306 can include materials such as metal and/or strong polymers that can bear the weight of a large display 102 without deforming. In some implementations, the fixed plate assembly 306 can be attached to the fixed structure 301 using at least four of the fasteners 502. Each one of the fasteners 502 can be positioned, e.g., adjusted, relative to an elongated fastener hole 503, wherein six upper elongated fastener holes 503 are shown along a top edge of the fixed plate assembly 306, and six lower elongated fastener holes 503 are shown along a bottom edge of the fixed plate assembly 306. Securing the at least four fasteners 502 maintains the fixed plate assembly 306 in a stationary position.

In some implementations, the tapered slot 504 can be cut out of a left central region of the fixed plate assembly 306, and the rectangular slot 505 can be cut out of a right central region of the fixed plate assembly 306. The tapered slot 504 and the rectangular slot 505 accept insertion of the ring grooved pins 302. When the groove 408 of the ring grooved pin 302 rests in the bottom of the tapered slot 504, translational motion of the display 102 is restricted in all directions. When the groove 408 of the ring grooved pin 302 rests in the bottom of the rectangular slot 505, translational motion of the display 102 is restricted in the y-direction and the z-direction.

FIG. 5B is a side elevation view of the pivoting plate assembly 308, according to a possible implementation of the present disclosure. In some implementations, parts of the pivoting plate assembly 308 can include fasteners 512 (e.g., screws, bolts, nails, etc.), elongated fastener holes 513, a T-shaped structure 506, a flexure bracket, e.g., a pivoting plate 507, and a flat plate 508. The pivoting plate assembly 308 can include materials such as metal and/or strong polymers that can withstand pressure of a large display 102 without deforming. In some implementations, the pivoting plate assembly 308 can be attached to the fixed structure 301 using two of the fasteners 512. Each one of the fasteners 512 can be positioned, e.g., adjusted, relative to an elongated fastener hole 513 formed in a T-shaped structure 506 of the pivoting plate assembly 308. The pivoting plate assembly 308 then hangs freely from the fasteners 512. That is, the lower portion of the pivoting plate assembly 308 is not secured to the fixed structure 301. Instead, the pivoting plate assembly 308 rests against a flat plate 508 that is attached, e.g., glued to, or otherwise adhered to, the fixed structure 301. The pivoting plate assembly 308 is then free to rotate, e.g., pivot, about the y-axis, like a see-saw that is balanced on the flat plate 508. As the pivoting plate assembly 308 moves relative to the flat plate 508, the top surface 412 of the body portion 416 of the contact pins 304 glide along a rear surface of the pivoting plate assembly 308.

FIG. 6 is an end view of the mounting system 300 in operation, according to a possible implementation of the present disclosure. FIG. 6 shows three-dimensional features of the fixed plate assembly 306 and the pivoting plate assembly 308 in the z-direction, normal to the fixed structure 301. In particular, FIG. 6 shows that the fixed plate assembly 306 bends away from the fixed structure 301 to couple with the ring grooved pins 302. Likewise, the pivoting plate assembly 308 bends away from the fixed structure 301 to make contact with the contact pins 304. As gravity pulls the display 102 downward in the -y direction, a force F1 on the top portion of the display 102 in the z-direction causes the ring grooved pins 302 to pull tightly against the fixed plate assembly 306. A force F2 in the -z direction, opposite the force F1, then causes the contact pins 304 to push against the pivoting plate assembly 308. In some implementations, the contact pins 304 can be threaded into the display 102 to adjust a pitch angle θ of the display 102 relative to the fixed structure 301. (In FIG. 6, the pitch angle θ shown is zero.) In some implementations, a nut can be secured against the back side of the display 102 to maintain the pitch adjustment of the contact pins 304 when the display 102 is removed from the fixed structure 301.

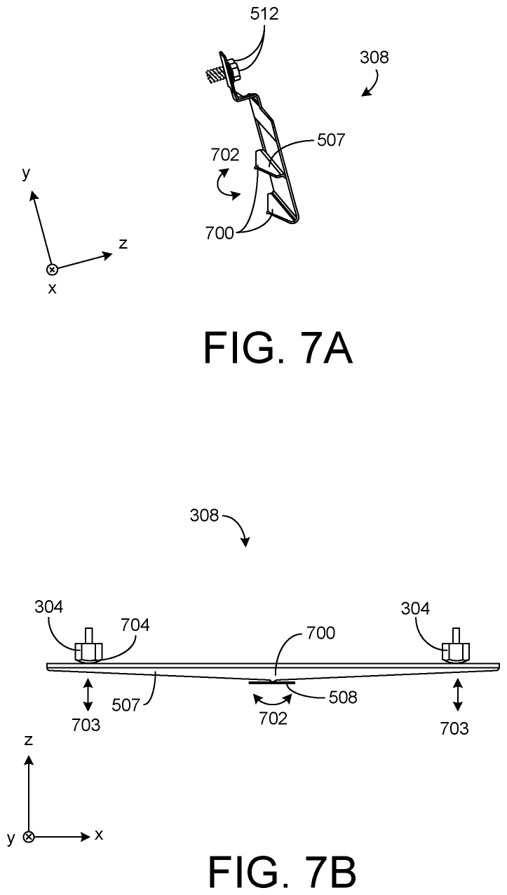

FIGS. 7A and 7B show features of a back side of the pivoting plate assembly 308, according to a possible implementation of the present disclosure. During operation of the mounting system 300, the back side of the pivoting plate assembly 308 faces fixed structure 301.

FIG. 7A is a close-up end view of the pivoting plate assembly 308, according to a possible implementation of the present disclosure. FIG. 7A shows rear pivot points 700 that rest against the flat plate 508 when the mounting system 300 is installed. FIG. 7A further shows that a rear profile of the pivoting plate 507 is formed with a tapered edge that tapers symmetrically, toward the rear pivot points 700. The rear pivot points 700 serve as contact points about which compensatory motion, e.g., a partial rotational motion, or pivoting motion 702 about the y-axis of the pivoting plate assembly 308, can occur. In some implementations, the flat plate 508 can be made of a rigid material, e.g., metal or hard plastic, that can support pressure on the rear pivot points 700 without deformation.

Compensatory motion can compensate for shifts in weight distribution or geometric changes due to thermal expansion, for example, that may alter the 3D orientation of the display 102. Consequently, when the display 102 is disturbed, the fixed plate assembly 306 constrains translational motion, while the pivoting plate assembly 308 compensates by allowing the pivoting motion 702, e.g., rotational motion to occur about a single axis, e.g., the y-axis, or vertical axis.

FIG. 7B is a bottom view of the pivoting plate assembly 308, according to a possible implementation of the present disclosure. FIG. 7B illustrates how a pivoting motion 702 occurs in response to pressure 703 of the contact pins 304 on respective ends of the pivoting plate 507. The pivoting motion 702 occurs around the rear pivot points 700. The pressure 703 is applied at pressure points 704 at which the contact pins 304 rest on the pivoting plate 507.

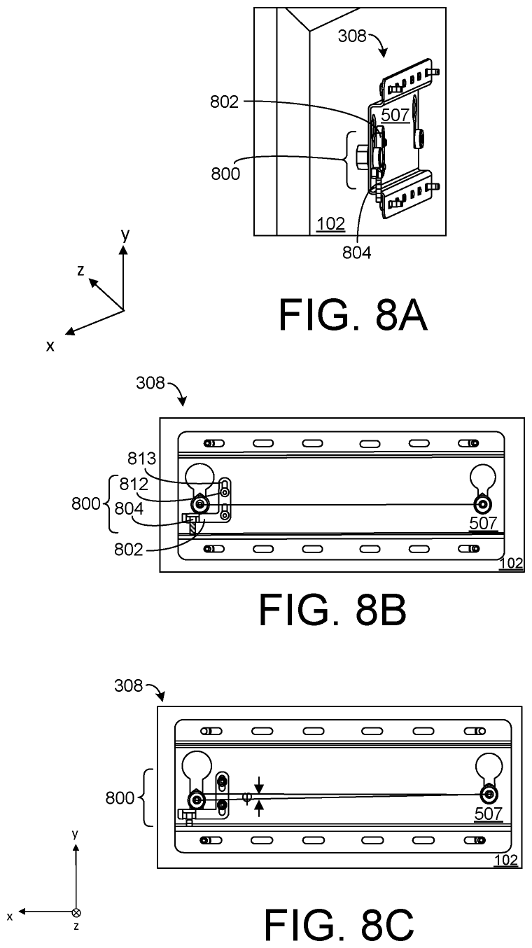

FIGS. 8A, 8B, and 8C show features of a pivoting plate assembly 308 cquipped with a roll adjustment mechanism 800, according to a possible implementation of the present disclosure. In some implementations, parts of the roll adjustment mechanism 800 can include fasteners 812 (e.g., screws, bolts, nails, etc.), elongated fastener holes 813, an L-shaped bracket 802, and a roll adjustment fastener 804.

FIG. 8A is a close-up perspective view of the roll adjustment mechanism 800, according to a possible implementation of the present disclosure. In particular, FIG. 8A illustrates operation of the roll adjustment fastener 804 (e.g., a screw, a bolt, etc.), which can be fastened (e.g., screwed) into a lower shelf of the pivoting plate 507.

FIGS. 8B and 8C are side elevation views of the roll adjustment mechanism 800, according to a possible implementation of the present disclosure. The L-shaped bracket 802 is attached to the pivoting plate 507 by the fasteners 812, which can be adjusted within the elongated fastener holes 813 to move the L-shaped bracket 802 vertically, in the y-direction. The roll adjustment mechanism 800 provides support for the left ring grooved pin 302 to be adjusted vertically within the tapered slot 504. That is, instead of the left ring grooved pin 302 resting at the bottom of the tapered slot 504, the left ring grooved pin 302 can rest on the L-shaped bracket 802 at various levels within the tapered slot 504, in accordance with a set position of the fasteners 812 within the elongated fastener holes 813. The angular orientation of the L-shaped bracket 802 can be adjusted by turning the roll adjustment fastener 804. As the left ring grooved pin 302 moves up and down with respect to the right ring grooved pin 302, a roll angle q of the display 102 can be adjusted to maintain the display 102 in a horizontal orientation. In FIG. 8B, the roll adjustment mechanism 800 is adjusted for zero roll, that is, the roll angle as shown in FIG. 8B is zero.

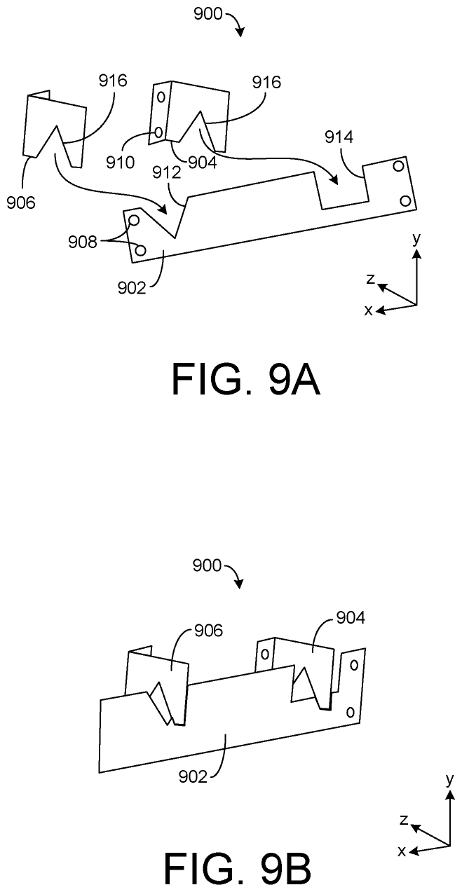

FIGS. 9A and 9B illustrate a top mounting assembly 900, according to a possible implementation of the present disclosure. The top mounting assembly 900 can achieve similar performance to the fixed plate assembly 306 in the mounting system 300, using a different structure. FIG. 9A illustrates components of the top mounting assembly 900, while FIG. 9B shows how the components work together to stabilize a load mounted on the fixed structure 301.

FIG. 9A shows parts of the top mounting assembly 900. In some implementations, parts of the top mounting assembly 900 can include a mounting bracket 902, a left hanger, or left flange 904, and a right hanger, or right flange 906. In some implementations, the mounting bracket 902, left flange 904, and right flange 906 can all be made from sheet metal, although other materials can be used. Fastener holes 908 (e.g., screw holes) are formed in the mounting bracket 902; fastener holes 910 (e.g., screw holes) are formed in the left flange 904 and the right flange 906.

The mounting bracket 902 can be attached, in a fixed position, to the fixed structure 301 at the fastener holes 908 using fasteners (not shown). In some implementations, the mounting bracket 902 is formed with a V-shaped cutout 912 and a square cutout 914.

The left flange 904 and the right flange 906 can be fixed, e.g., attached in a fixed, or non-adjustable, position, to the display 102 at the fastener holes 910 using fasteners (not shown). The right flange 906 is formed as an L-shaped metal plate that has a V-shaped cutout 916. The left flange 904 is formed as an L-shaped metal plate that has the same V-shaped cutout 916. A portion of the left flange 904 in which the fastener holes 910 are formed can be bent at a right angle to the portion that has the V-shaped cutout 916. A portion of the right flange 906 in which the fastener holes 910 are formed can be bent at an opposite right angle to the portion that has the V-shaped cutout 916, so that the left flange 904 and the right flange 906 are mirror images of one another. In operation, the V-shaped cutout 916 of the left flange 904 can be mounted onto the V-shaped cutout 912 of the mounting bracket 902. Likewise, the V-shaped cutout 916 of the right flange 906 can be mounted onto the V-shaped cutout 912 of the mounting bracket 902. Similar to the fixed plate assembly 306, the top mounting assembly 900 constrains translational motion of the display 102, while permitting angular motion of the display 102 with respect to the pivoting plate assembly 308.

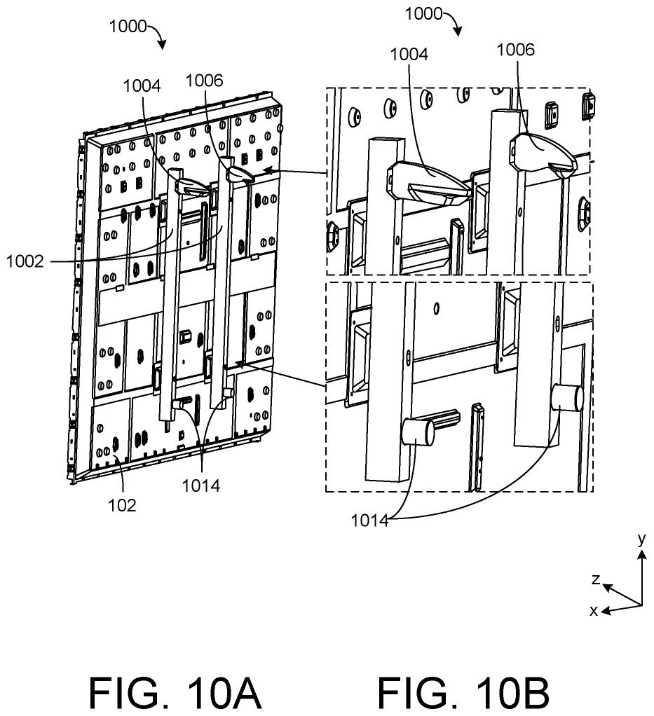

FIGS. 10A, 10B, 10C, and 10D illustrate a mounting assembly 1000, according to a possible implementation of the present disclosure. The mounting assembly 1000 can achieve similar performance to the mounting system 300 and/or the top mounting assembly 900, using a different structure that includes partial sphere contacts, e.g., connectors in the shape of conical sections of spheres. The use of partial sphere contacts can be advantageous by reducing Hertz contact stress. FIGS. 10A and 10B illustrate components of the mounting assembly 1000 that attach to the display 102, while FIGS. 10C and 10D illustrate support structures for the mounting assembly 1000, for attachment to the fixed structure 301.

FIG. 10A shows parts of the mounting assembly 1000, according to a possible implementation of the present disclosure. In some implementations, parts of the mounting assembly 1000 include rails 1002, a first partial sphere contact 1004, a second partial sphere contact 1006, and contact pins 1014, which may be similar to the contact pins 304 of FIGS. 3 and 4C. In some implementations, the rails 1002 attach to a back side of the display 102, and the contact pins 1014 can be inserted into holes in the rails 1002. The contact pins 1014 can then interact with the pivoting plate assembly 308 as described above. The first partial sphere contact 1004 and the second partial sphere contact 1006 can also be inserted into holes in the rails 1002. The rails 1002 can be oriented substantially parallel to one another.

FIG. 10B shows magnified views of the first partial sphere contact 1004 and the second partial sphere contact 1006 in a top panel, and magnified views of the contact pins 1014 in a bottom panel. In some implementations, the first partial sphere contact 1004 and the second partial sphere contact 1006 can have the form of different partial spheres for insertion into different shaped support structures, as shown in FIGS. 10C and 10D. For example, in some implementations, the first partial sphere contact 1004 can be a canoe ball contact and the second partial sphere contact 1006 can be a pivot flat contact.

FIG. 10C illustrates a triangular support structure 1008 for the first partial sphere contact 1004, according to a possible implementation of the present disclosure. When the first partial sphere contact 1004 is inserted into the triangular support structure 1008, translational motion of the display 102 is restricted in all directions.

FIG. 10D illustrates a V-shaped trough 1010, e.g., a tapered or V-shaped groove, that can be used as a support structure for the second partial sphere contact 1006, according to a possible implementation of the present disclosure. When the second partial sphere contact 1006 is inserted into the V-shaped trough 1010, translational motion of the display 102 is restricted in the y-and z-directions.

The terminology used herein is for the purpose of describing particular embodiments only and is not intended to be limiting of the embodiments. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of the stated features, steps, operations, elements, and/or components, but do not preclude the presence or addition of one or more other features, steps, operations, elements, components, and/or groups thereof.

It will be understood that when an element is referred to as being “coupled,” “connected,” or “responsive” to, or “on,” another element, it can be directly coupled, connected, or responsive to, or on, the other element, or intervening elements may also be present. In contrast, when an element is referred to as being “directly coupled,” “directly connected,” or “directly responsive” to, or “directly on,” another element, there are no intervening elements present. As used herein the term “and/or” includes any and all combinations of one or more of the associated listed items.

Spatially relative terms, such as “beneath,” “below,” “lower,” “above,” “upper,” and the like, may be used herein for ease of description to describe one element or feature in relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below”, or “beneath” other elements or features would then be oriented “above” the other elements or features. Thus, the term “below” can encompass both an orientation of above and below. The device may be otherwise oriented (rotated 70 degrees or at other orientations) and the spatially relative descriptors used herein may be interpreted accordingly.

Example embodiments of the concepts are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments of the described concepts should not be construed as limited to the particular shapes of regions illustrated herein but are to include deviations in shapes that result, for example, from manufacturing. Accordingly, the regions illustrated in the figures are schematic in nature and their shapes are not intended to illustrate the actual shape of a region of a device and are not intended to limit the scope of example embodiments.

It will be understood that although the terms “first,” “second,” etc. may be used herein to describe various elements, these elements should not be limited by these terms. These terms are only used to distinguish one element from another. Thus, a “first” element could be termed a “second” clement without departing from the teachings of the present embodiments.

Unless otherwise defined, the terms (including technical and scientific terms) used herein have the same meaning as commonly understood by one of ordinary skill in the art to which these concepts belong. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

While certain features of the described implementations have been illustrated as described herein, many modifications, substitutions, changes, and equivalents will now occur to those skilled in the art. It is, therefore, to be understood that the appended claims are intended to cover such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components, and/or features of the different implementations described.

What is claimed is:

1. A device for mounting a display to a fixed structure, the device comprising:
a first mounting plate attached to the fixed structure, the first mounting plate having a first slot and a second slot to accept ring grooved pins attached to the display;
a second mounting plate configured to pivot about a vertical axis, the second mounting plate configured to accept contact pins attached to the display;
a flat plate attached to the fixed structure, the flat plate configured to support a lower portion of the second mounting plate; and
an adjustable bracket attached to the fixed structure, the adjustable bracket configured to support an upper portion of the second mounting plate, the adjustable bracket configured to permit compensatory motion of the display.

2. The device of claim 1, wherein the first slot has a first keyhole shape and the second slot has a second keyhole shape that differs from the first keyhole shape.

3. The device of claim 2, wherein the first keyhole shape has a tapered lower end.

4. The device of claim 2, wherein the second keyhole shape has a rectangular lower end.

5. The device of claim 1, wherein the second mounting plate has a tapered edge configured to mate with the flat plate at a pivot point.

6. The device of claim 1, wherein the first mounting plate is equipped with a roll adjustment mechanism.

7. The device of claim 1, wherein the second mounting plate is equipped with a pitch adjustment mechanism.

8. A system, comprising:
a mount attached to a fixed structure, the mount configured to restrict translational motion of a hanging object relative to the fixed structure; and
a flexure bracket attached to the fixed structure, the flexure bracket configured to permit rotational motion of the hanging object around a single axis.

9. The system of claim 7, wherein the mount includes a keyhole that accepts insertion of a grooved pin attached to the hanging object.

10. The system of claim 7, wherein the mount includes a V-shaped groove that accepts insertion of a partial sphere contact attached to the hanging object.

11. The system of claim 9, wherein the partial sphere contact includes at least one of a canoe ball contact or a pivot flat contact.

12. The system of claim 7, wherein the mount includes a V-shaped cutout and a rectangular cutout configured to mate with flanges attached to the hanging object.
